(19) United States
(12) Patent Application Publication
(10) Pub. No.: US 2012/0265699 A1
(43) Pub. Date: Oct. 18, 2012

(54) INTELLECTUAL ASSET DOCKETING INTERFACE

(75) Inventors: Priya Iyer, Wellesley, MA (US); Kelly Crawford, Sundance, WY (US); David Bartle, Acton, MA (US); Erik Bailey, Needham, MA (US); Denise Cheung, Wellesley, MA (US); Tammy M. Krieger, Bothell, WA (US); Brent E. Marble, Seattle, WA (US)

(73) Assignee: ANAQUA, INC., Boston, MA (US)

(21) Appl. No.: 13/448,166

(22) Filed: Apr. 16, 2012

Related U.S. Application Data
(60) Provisional application No. 61/476,567, filed on Apr. 18, 2011.

(51) Int. Cl. G06Q 50/00

(52) U.S. Cl. 705/310

(57) ABSTRACT

Example embodiments relate to museum docketing interfaces. An example embodiment includes a method of intellectual asset docketing. The method includes displaying a customizable docketing interface for a first intellectual asset record. The docketing interface includes multiple panels and each panel includes multiple related fields. The method additionally includes detecting user input into a first field of the docketing interface and closing at least one task for the first intellectual asset record based at least in part on the user input.

### CROSS-REFERENCE TO RELATED APPLICATIONS

This application claims the benefit of and priority to U.S. Provisional Application No. 61/476,567, filed on Apr. 18, 2011 which is incorporated herein by reference.

### TECHNICAL FIELD

Embodiments relate generally to intellectual asset docketing and management. More particularly, some embodiments relate to docketing interfaces.

### BACKGROUND

A docketing system is utilized to schedule legal matters and manage aspects of intellectual assets. Intellectual assets include for example: patents, trade secrets, publications, trademarks, domain names, and copyrights. An intellectual asset management (IAM) system may support docketing and other related activities in the full lifecycle of intellectual assets, such as invention disclosure submission, trademark search requests, multi-party collaboration, document and e-mail management, configurable business workflow rules, and business intelligence tools, among other features. An IAM system provides visibility and access to internal and external participants in the intellectual asset management process—for example, attorneys, agents and paralegals, researchers and engineers, portfolio managers, marketing, licensing professionals and other business managers.

A challenge facing users of intellectual asset docketing and management systems is being able to quickly and efficiently manage docketing data. For each active intellectual asset, there are numerous metadata, including important dates, which must be accurately entered, tracked, modified, closed, etc. Some intellectual asset docketing and management systems provide access to these metadata, but do so with the information spread out across multiple screens, windows, data groups, and the like. Additionally, docketing users are normally exposed to all of this information with a predetermined arrangement that is the same for all docketing users of a given intellectual asset docketing and management system, regardless of the specific information each docketing user typically needs to access.

### BRIEF SUMMARY OF SOME EXAMPLE EMBODIMENTS

Embodiments relate generally to intellectual asset docketing and management. More particularly, some embodiments relate to docketing interfaces. In one example embodiment, a method of intellectual asset docketing is provided, wherein the method includes displaying a customizable docketing interface for a first intellectual asset record, the docketing interface including a plurality of panels, wherein each panel of the plurality of panels includes a plurality of related fields; detecting user input into a first field of the docketing interface; and closing at least one task for the first intellectual asset record based at least in part on the user input. The user input may include at least one of a date and a reference identifier. Additionally, the method may further include storing the user input for the first field in the intellectual asset record. The method may further include displaying, for the first field, an indication of the at least one task to be closed in response to the user input into the first field. Moreover, the method may further include deriving the first field to display based on preconfigured workflow for at least one of an intellectual asset type and the at least one task. The method may also further include displaying at least one field of the plurality of fields within a panel of the plurality of panels in response to a user request to expand the panel, and hiding the plurality of fields within the panel in response to a user request to collapse the panel. Furthermore, the method may also further include displaying the plurality of fields within the plurality of panels in response to a user request to expand all panels of the plurality of panels, and hiding the plurality of fields within the plurality of panels in response to a user request to collapse all panels of the plurality of panels. Additionally, the method may further include relocating a panel of the plurality of panels in response to a user request to move the panel to a new location within the docketing interface. The method may also include saving a current layout of the docketing interface, and associating the layout with a docketing user.

In an example embodiment, a docketing server comprising at least one memory device for storing one or more intellectual asset records and a controller operatively connected to the at least one memory device is provided. The docketing server controller displays a customizable docketing interface for a first intellectual asset record, the docketing interface comprising a plurality of panels, wherein each panel of the plurality of panels includes a plurality of related fields; detects user input into a first field of the docketing interface; and closes at least one task for the first intellectual asset record based at least in part on the user input. In some example embodiments, the controller further stores the user input for the first field in the intellectual asset record. Also, in some example embodiments, the controller further hides one or more panels of the plurality of panels based on panel permissions for a docketing user. Additionally, the controller may further display a list of one or more actions to be triggered by the user input, and prompt a docketing user to confirm the list prior to the closure of the at least one task. The docketing interface may further include at least one of a previous record object and a next record object, and the controller preferably further displays the docketing interface for a second intellectual asset record in response to user selection of one of the previous record object and the next record object, wherein displaying the docketing interface for the second intellectual asset record includes maintaining positions and states of the plurality of panels from the docketing interface for the first intellectual asset record. Optionally the controller may further create at least one new task for the first intellectual asset record based at least in part on the user input.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description, which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only embodiments of the invention and are therefore not to be considered limiting of its scope. The invention will be described and explained with additional specificity and detail through the use of the accompanying drawings in which:

FIG. 1 illustrates an example docketing system including an example docketing server;

FIG. 2A illustrates an example docketing server of the docketing system of FIG. 1;

FIG. 2B illustrates example data that may be stored as part of an intellectual asset record on the docketing server of FIG. 2A;

FIG. 3 is a block diagram illustrating an example docketing user interface object that may be included in the docketing system of FIG. 1;

FIGS. 4A and 4B are block diagrams illustrating example intellectual asset docketing panels of the docketing user interface object of FIG. 3 expanding and collapsing;

FIGS. 5A and 5B are block diagrams illustrating example intellectual asset docketing panels of the docketing user interface object of FIG. 3 all expanding;

FIG. 6 is a block diagram illustrating example intellectual asset docketing panels of the docketing user interface object of FIG. 3 all collapsing;

FIG. 7 illustrates an example docketing user interface object for a second intellectual asset record;

FIGS. 8A and 8B illustrate relocating a panel within the docketing user interface object of FIG. 3;

FIG. 9 is a block diagram illustrating an example a workflow report UI object;

FIG. 10 illustrates an example method for docketing interface display;

FIG. 11 illustrates an example method for handling user interaction with an intellectual asset docketing interface;

FIG. 12 illustrates a block diagram illustrating an example computing device arranged for a method for related art citation management.

### DETAILED DESCRIPTION

Embodiments relate generally to intellectual asset docketing and management. More particularly, some embodiments relate to docketing interfaces.

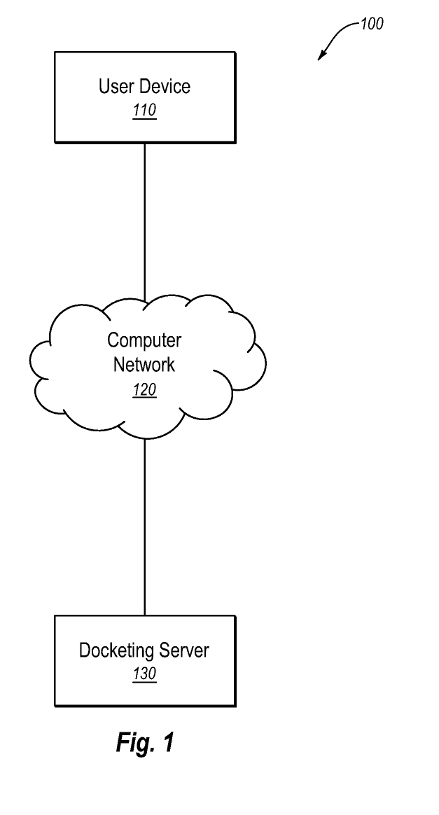

FIG. 1 illustrates an example docketing system 100. The docketing system 100 generally provides one or more docketing users (not shown) with a docketing service (not shown). The docketing system 100 may include a user device 110 communicatively coupled to a docketing server 130 via a computer network 120. The coupling between the docketing server 130 and the user device 110 may enable the docketing user to access at least some portion of a docketing service stored or otherwise available on the docketing server 130.

The docketing service may generally schedule legal matters and manage aspects of those legal matters. For example, an intellectual property docking service may support scheduling a disclosure submission and manage the related filing dates such as provisional application filing, non-provisional conversion dates, maintenance fees, and the like. The management and scheduling of these legal matters may be managed by a docketing server application (described below) which may include a set of templates, data, instructions, applications, computer programs, or some combination thereof. Alternatively or additionally, the docketing system 100 may provide a visible, accessible, user-interface to internal and/or external entities through which the legal matters are manually managed. Specifically, as described herein, the docketing service may include various docketing server applications that include one or more user interface (UI) objects, for instance, to enable the docketing user to manage related art citation.

The user device 110 in FIG. 1 may be a desktop computer, a laptop computer, a portable electronic device such as a cellular/mobile/smart phone, a tablet personal computer, a personal digital assistant, or any equivalent device. The user device 110 may include a docketing client software to access the docketing server 130, or the user device 110 may include a web browser to access the docketing server 130, where the docketing server 130 provides the docketing service as a web application. Alternatively, the user device 110 may communicate with the docketing server 130 through other means, such as a remote desktop connection.

Additionally, the user device 110 communicates with the docketing server 130 via the computer network 120. The computer network 120 relates to a collection of devices interconnected by communication channels that enables sharing of information among the interconnected devices. In this example embodiment, the computer network 120 may be or include any wired or wireless network technology such as optical fiber, electrical cables, Ethernet, radio waves, microwaves, an infrared transmission, wireless internet, communication satellites, cellular telephone signals, or an equivalent-networking signal that interfaces with devices to create a network. Specifically, in one embodiment, the user device 110 communicates with the docketing server 130 via the internet. In other embodiments, the user device 110 may be directly coupled with the docketing server 130 and/or may be integrated directly with, and be a part of, the docketing server 130.

In FIG. 1, one user device 110 is operably coupled to communicate with the docketing server 130 via the computer network 120. However, in alternative embodiments a plurality of user devices 110 which may include various types of user devices 110 may simultaneously communicate with the docketing server 130. Additionally or alternatively, the docketing system 100 may include multiple docketing servers 130 which are operably coupled to communicate information among the multiple docketing servers 130 and/or to communicate information among various user devices 110 operably coupled to communicate with the docketing servers 130.

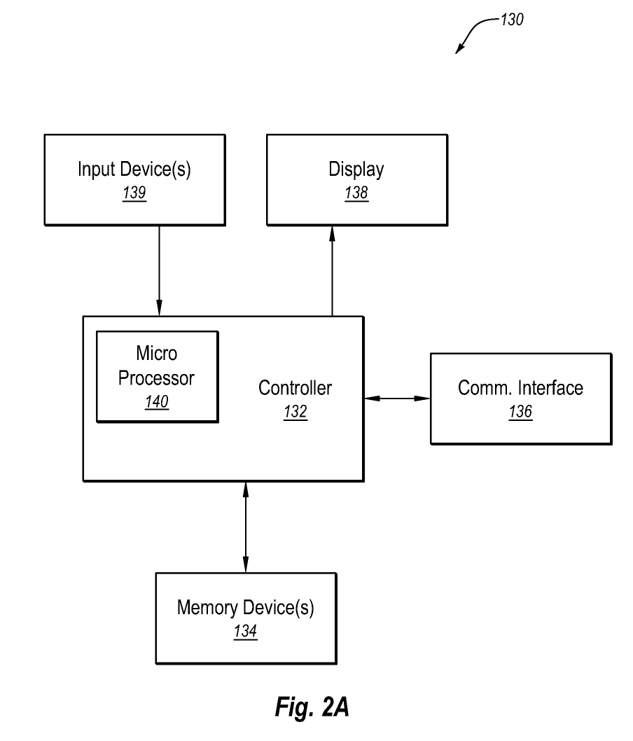

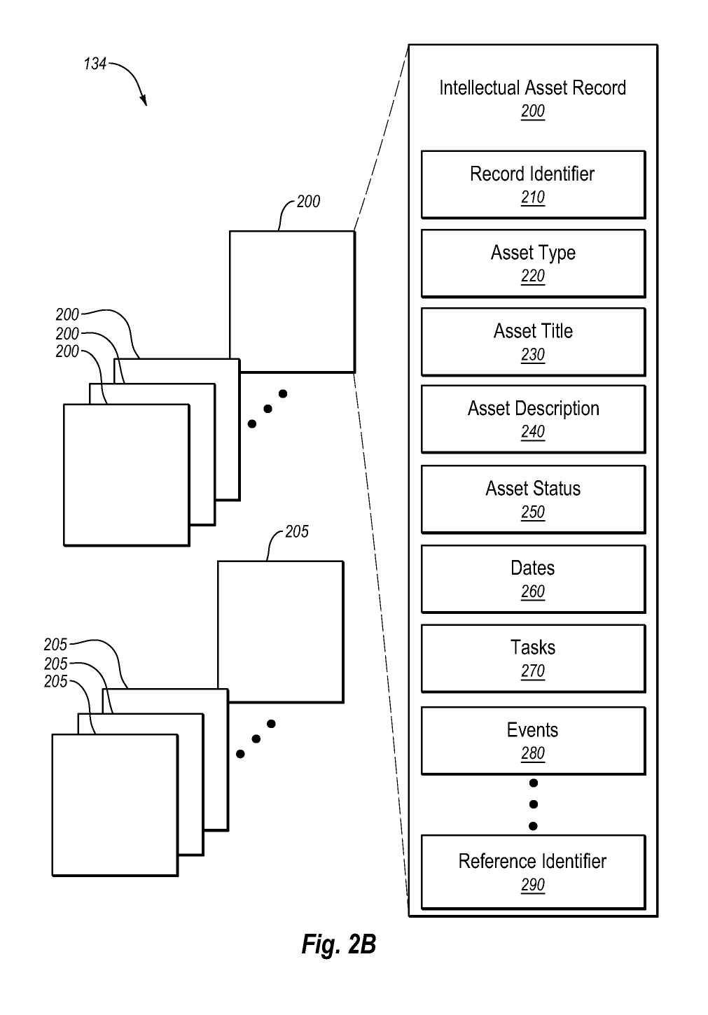

FIG. 2A illustrates additional details of the docketing server 130 of FIG. 1. As depicted in FIG. 2A, the docketing server 130 may include a controller 132 and a memory device 134. The controller 132 may include a microprocessor 140 which executes a docketing server application (not shown). The docketing server application may include templates, data, instructions, applications, or computer programs stored in a memory device 134. The docketing server application may vary as necessary to implement the docketing service.

In the embodiment illustrated in FIG. 2A, the controller 132 is operatively coupled to the memory device 134, which enables the controller 132 through the microprocessor 140 to access information stored on the memory device 134 such as the docketing server applications, an intellectual asset record (IA record) (described below), and/or a file (described below). The memory device 134 may provide data to the controller 132 in various forms, such as, but not limited to, database records, files, bitstreams, and bytestreams, and the memory device 134 may include volatile or non-volatile memory or storage.

As depicted in FIG. 2A, the docket server 130 can include a single controller 132, which can include one microprocessor 140 that executes a docketing server application, and a single memory device 134. However, in alternative embodiments, the docket server 130 may include one or more controllers 132, one or more microprocessors 140, which execute a plurality of docketing server applications, and one or more memory devices 134. The one or more memory devices 134 may be remotely located from each other and/or from the controller 132.

The docketing server 130 can include a communication interface 136. The communication interface 136 enables the docketing server 130 to communicate with a user device via a computer network. For example, with combined reference to FIGS. 2A and 1, the communication interface 136 may enable the user device 110 to communicate to the docketing server 130 via the computer network 120. Additionally, the communication interface 136 may enable the docketing server 130 to communicate with other docketing server applications either publically or privately available on the internet or through an interface between multiple docketing servers 130, which are operably connected via the computer network 120. Examples of the communication interface 136 include any receiver or transmitter capable of functioning with the computer network 120.

Referring back to FIG. 2A, the docketing server 130 may include a display 138 and one or more input devices 139. The docketing user (not shown) and/or a docketing server administrator (not shown) may directly interface and/or control the docketing server 130 through the display 138 and the input devices 139. Examples of the display 138 may include a thin film transistor liquid crystal display, liquid crystal display or an equivalent structure. Examples of the input devices 139 may include a QWERTY key pad, a ten key input pad, a mouse, a stylus, voice recognition software, an audio mixer, or may be integrated with the display 138 as in a touchscreen device using a surface acoustic wave, surface capacitance, projected capacitance, or an equivalent structure.

Turning next to FIG. 2B, additional details of the memory device 134 of FIG. 2A are disclosed. FIG. 2B illustrates data that may be stored in the memory device 134. Specifically, in some embodiments the data may include intellectual asset records (IA record) 200 and/or files 205.

In alternative embodiments, the files 205 and the IA records 200 may be stored separately. For example, the files 205 may be stored on a first memory device and the IA records 200 may be stored on a second memory device. In this and other example embodiments, the first memory device may be located in a docketing server such as the docking server 130 of FIG. 2A and the second memory device may be located in a remote site. Alternatively, the files 205 and the IA records 200 may both be stored on a single memory device 134. Additionally or alternatively, other data may be stored in the memory device 134 including but not limited to docketing server applications, networking information, docketing user demographic or statistical information, docketing server administrator permissions, etc.

FIG. 2B further illustrates potential contents of the IA records 200. Generally, the IA records 200 include a set of related data organized into meaningful units that pertain to an intellectual asset such as a patent, a trademark, copyright, or the like. For example, the set of related data of the IA records 200 may be organized into the meaningful units including a record identifier 210, an asset type 220, an asset title 230, an asset description 240, an asset status 250, a date 260, a task 270, an event 280, and a reference identifier 290. Each of these meaningful units will be briefly discussed below.

With respect to the embodiment illustrated in FIG. 2B, the record identifier 210 is an identifier uniquely identifying the IA record 200 and can be used to reference the IA record 200. The asset type 220 may be used to distinguish between various types of intellectual assets, such as patents, trademarks, copyrights, trade secrets, etc. The asset title 230 may provide a human-readable name for the IA record 200, and the asset description 240 may provide a human-readable summary of the IA record 200. The asset status 250 may indicate the current status such as pending, abandoned, issued, etc. of the intellectual asset associated with the IA record 200.

The date 260 may include one or more dates associated with an intellectual asset. Examples of the dates 260 may include, but is not limited to, filing dates related to the intellectual asset, non-provisional conversion dates, priority dates, granted dates, dates that maintenance fees are due, dates that an office action was received and/or due, and the like.

Generally, the task 270 denotes an action for a specified docketing user to complete by a specified time. Some examples of the task 270 may include, but are not limited to, instructing outside counsel, attending meetings, etc. The task 270 may be a plurality of tasks 270. That is, multiple tasks 270 may be, and commonly are, associated with the IA record 200. The event 280 may include a historical log of an important event that has occurred during a lifecycle of the IA record 200. A plurality of events 280 may be associated with the IA record 200. The reference identifier 290 is an identifier to uniquely identify a product associated with the IA record 200, such as a patent or trademark application, a pre-grant publication, or an issued trademark or patent. A plurality of reference identifiers 290 may be associated with the IA record 200.

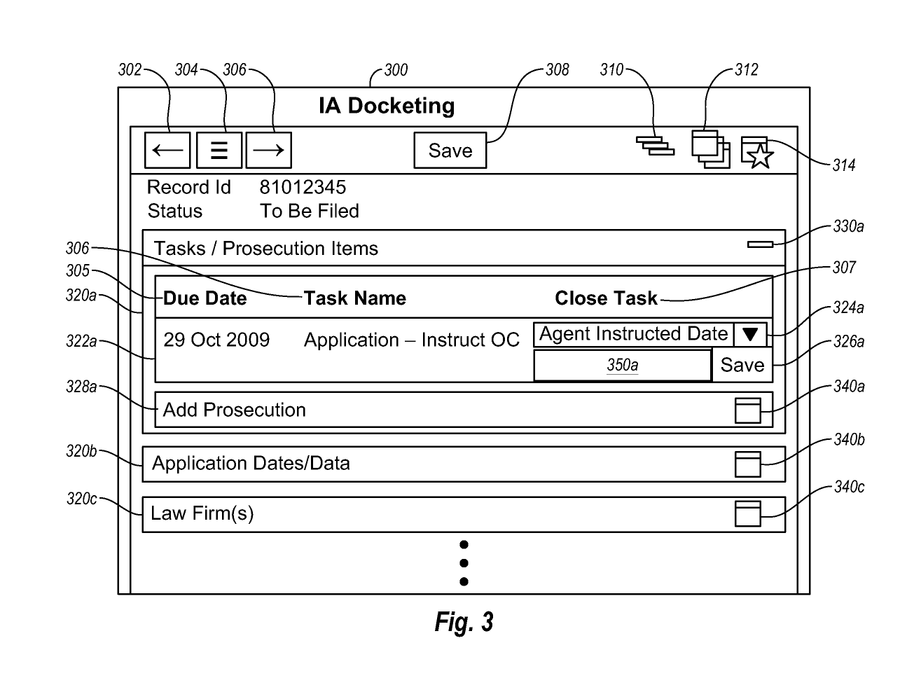

FIG. 3 is a block diagram depicting an example docketing UI object (docketing interface) 300. In some embodiments, the docketing interface 300 may provide the docketing user with, for example, details on docketing metadata for a first IA record 200. Additionally, the docketing interface 300 may enable the docketing user to manage docketing metadata for the first IA record 200. The docketing interface 300 may be defined, controlled, displayed, or some combination thereof, by the docketing server 130. The controller 132 of the docketing server 130 may display UI objects through the user device 110 for interaction with the docketing user. In some embodiments, the controller 132 may also utilize client-side scripting at the user device 110 to make user interaction more responsive. In some embodiments, the docketing interface 300 may be a subcomponent of a parent interface or a superset UI object (not shown), such as an encompassing parent window.

The docketing interface 300 may include numerous UI objects. Some of the UI object may relate to contents of the IA records 200. For example, for the first IA record 200, the record identifier (“record ID” in FIGS. 3-9) 210 has a value of ‘81012345’, and the asset status 250 has a value of “To Be Filed”.

The docketing interface 300 may be displayed as a result of an intellectual asset search (IA search) performed within the docketing system 100. If the docketing interface 300 is displayed as a result of the IA search, then search result objects 302, 304, and 306 may be included within the docketing interface 300. The search result objects 302, 304, and 306 may enable the docketing user to view and manage various IA records 200 that are displayed as a result of the IA search. To this end, the search result objects 302, 304, and 306 may include a previous intellectual asset record UI object (previous record object) 302, a search result set UI object 304, and a next intellectual asset record UI object (next record object) 306.

The docketing interface 300 may also include a save changes UI object 308, a minimize all panels UI object 310, a maximize all panels object 312, and a save layout UI object 314. The minimize all panels UI object 310 and the maximize all panels object 312 generally enable the docketing user to variously and selectively view panels to modify and/or manage information contained therein. Additionally, the save layout UI object 314 and the save changes UI object 308 enable the docketing user to save changes to the IA record 200 that may be performed using the docketing interface 300.

Additionally, the docketing interface 300 may include one or more movable intellectual asset docketing panels 320a, 320b, and 320c (collectively, a panel 320). Including three panels 320 within FIG. 3 is for illustrative purposes only, as the docketing interface 300 may include any number of the panels 320.

Each of the panels 320 may include one or more related fields (generally, a field 322), such as a first field 322a. The fields 322 may relate to the type of the panel 320 and/or information organized therein. For example, in the depicted embodiment, a first panel 320a is a task/prosecution item panel and includes the first field 322a related to tasks and prosecution items. In addition, a second panel 320b is an application dates/data panel and accordingly may include one or more fields 322 related to application dates and data. In addition, a third panel 320c is law firm(s) panel and accordingly may include one or more fields 322 related to law firms. Each panel 320 may respectively include at least one of a minimize panel UI object 330 such as a first minimize panel UI object 330a, and a maximize panel UI object 340 such as a first maximize panel UI object 340a. For example, the first panel 320a includes the first minimize panel UI object 330a, and the second and third panels 320b and 320c include a second and third maximize panel UI objects 340b and 340c, respectively.

Referring to the first panel 320a, which is a tasks/prosecution items panel, the first field 322a for the first IA record 200 may include a due date field 305, a task name field 306, and a close task field 307. The values for the due dates field 305 and the task name field 306 in the example of FIG. 3 are ‘29 Oct. 2009’ and ‘Application-Instruct OC’, respectively. These values may indicate that for a task 270 the outside counsel should be instructed to file an application by Oct. 29, 2009.

The docketing user can utilize the close task field 307 to enter a date into a date metadata entry area 350a (generally, a metadata entry area 350) of the first field 322a with a selected type of date chosen using a drop-down 324. Generally, the metadata entry area 350 may receive various user input such as a date, an application number, a priority date, for instance. In the depicted embodiment, a first drop-down 324a (generally, a drop-down 324) provides for a selection of a type of important date. That is, for the first panel 320a, the docketing user may enter a date into the date metadata entry area 350a, leave the first drop-down 324a to a default date type value, or choose another date type value from the first drop-down 324a. In the depicted embodiment, the date metadata entry area 350a is included in the first field 322a. However, this depiction is not meant to be limiting. Any or all of the panels 320 may include the date metadata entry area 350a or any other type of metadata entry area 350 depending on the information contained in the field 322.

The close task field 307 may also include a save metadata UI object 326a. The depicted embodiment includes the save metadata UI object 326a in the first panel 320a, however one or more panels 320 may include a save metadata UI object similar to the save metadata UI object 326a. The save metadata UI object 326a may enable the docketing user to save a date entered into the date metadata entry area 350a. Additionally, in some examples the save metadata UI object 326a may save and close the task 270.

Each of the panels 320 may also include a subpanel 328, such as a first subpanel 328a. The first subpanel 328a includes UI objects like those of the panels 320. That is, the subpanels 328 includes multiple fields 322, such as the first field 322a, one or more additional subpanels 328 (not shown), the minimize panel UI object 330, the maximize panel UI object 340 or some combination thereof. Various UI objects, such as the minimize panel UI object 330 and/or the maximize panel UI object 340, subpanels 328, or fields 322, may be included based on the type of subpanel 328 or information organized therein. For example, the first subpanel 328a is an add prosecution subpanel, and accordingly the fields 322, may be related to adding prosecution items for the first panel 320a.

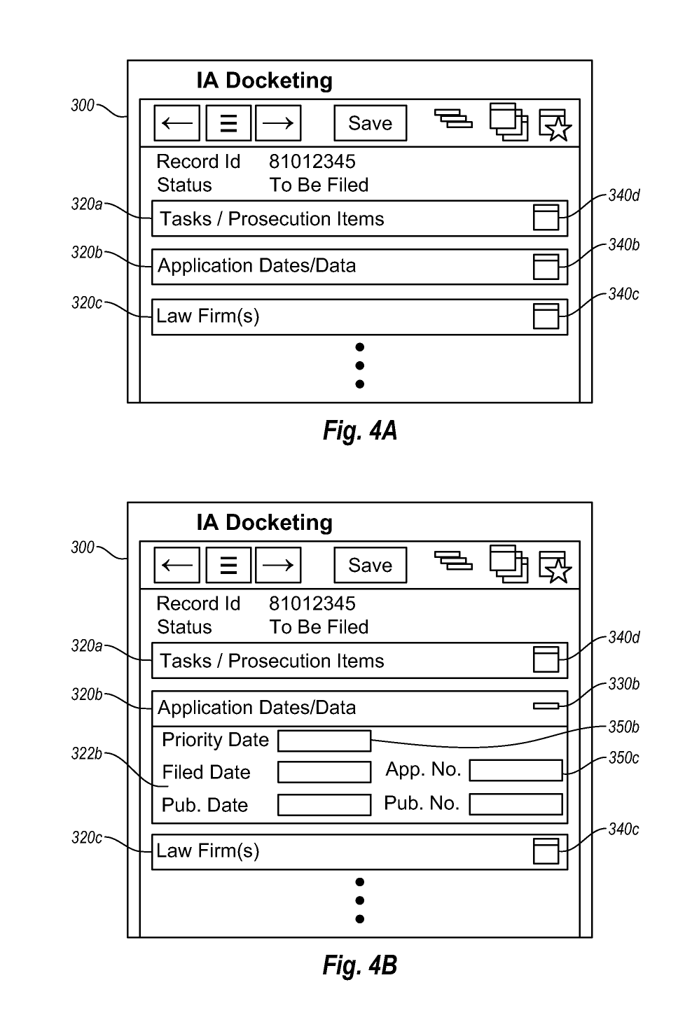

FIGS. 4A and 4B illustrate block diagrams depicting the docketing interface 300 with the panels 320 expanded and/or collapsed. Collapsing and expanding the panel 320 enables the docketing user to hide or show metadata included in the fields 322 that are of relevance to that particular docketing user. That is, the fields 322 that are not of interest to the docketing user can be hidden by collapsing one or more of the panels 320. This may free the docketing interface 300 from unnecessary clutter, enabling the docketing user to review and access only specific metadata of relevance.

More specifically, FIGS. 4A and 4B illustrate an example embodiment in which the second panel 320b of interest to the docketing user is expanded to show information in a second field 322b. Expansion of the second panel 320b is for illustrative purposes only, as any of the panels 320 may expanded or collapsed in substantially the same manner. If the docketing user wished to view and/or modify contents of the second field 322b within the second panel 320b, the docketing user may expand the second panel 320b. To expand the second panel 320b, the docketing user may select a second maximize panel UI object 340b, thereby modifying the UI objects displayed within the docketing interface 300. In response to selection of the second maximize panel object 340b, the docketing server 130 displays of the second field 322b. As depicted in FIG. 4B, the second field 322b may include various metadata entry areas 350. For example, the second field 322b includes a priority date metadata entry area 350b and an application number metadata entry area 350c. In some embodiments, the reference identifier 290 as described with respect to FIG. 2 may be entered into the application number metadata entry area 350c.

Conversely, selection of the minimize panel UI object 330 may collapse the panel 320. For example, to collapse the second panel 320b, the docketing user selects the second minimize panel UI object 330b. The docketing interface 300 of FIG. 4B reverts to the docketing interface 300 displayed in FIG. 4A.

Additionally, expanding and collapsing the panels 320 may affect the minimize panel UI object 330 and the maximize panel UI object 340. For example, when the second panel 320b is expanded, the second maximize panel UI object 340b is replaced by a second minimize panel UI object 330b as illustrated in FIG. 4B. Similarly, when the second panel 320b collapsed, the second minimize panel UI object 330b is replaced by the second maximize panel 340b.

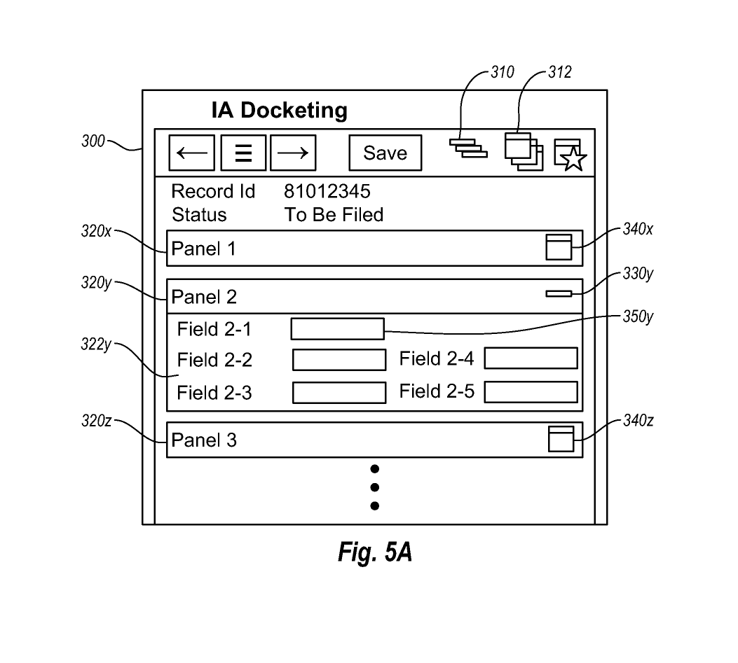

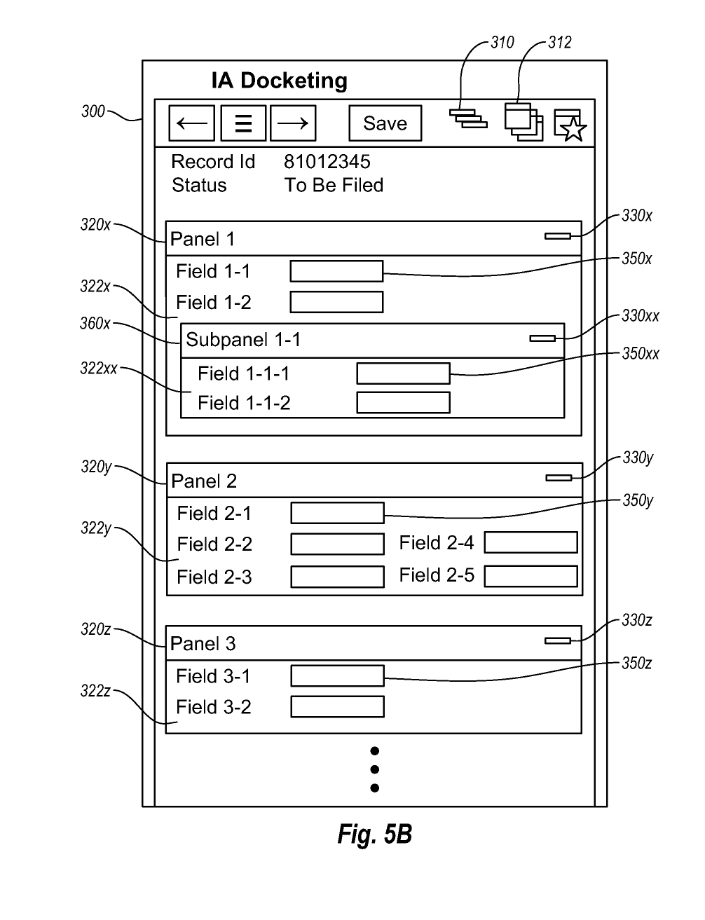

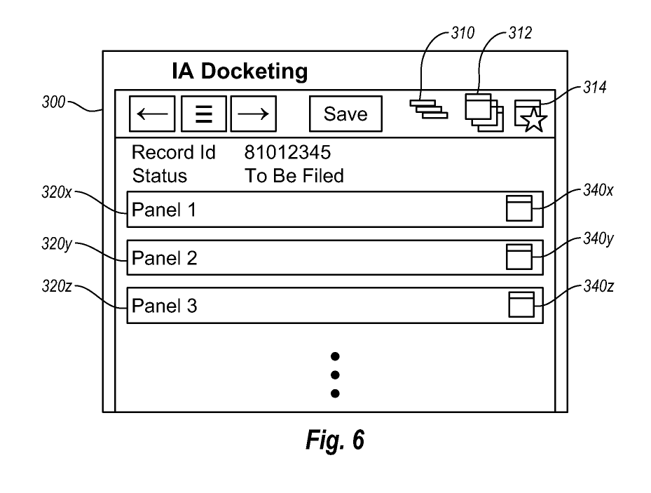

In addition to being able to expand and collapse the individual panels 320, the docketing user may also expand and collapse all panels 320 of the docketing interface 300 as illustrated in FIGS. 5A, 5B, and 6. The docketing interface 300 as shown in FIG. 5A includes ‘Panel 1’ 320x, ‘Panel 2’ 320y, and ‘Panel 3’ 320z.

In FIG. 5A, the Panel 1 320x and Panel 3 320z are collapsed and the Panel 2 320y is expanded. Because the Panel 2 320y is expanded, the docketing interface 300 displays Panel 2 ields 322y, including a Panel 2 metadata entry area 350y for Field 2-1. The type of information for entry into the Panel 2 metadata entry area 350y may be, for example, a date, a text string, a number, etc. Because the Panel 1 320x and the Panel 3 320z are collapsed, the Panel 1 and Panel 3 maximize panel UI objects 340x and 340z, respectively are displayed within the Panel 1 320x and Panel 3 320z, while the Panel 2 minimize panel UI object 330y is displayed within expanded Panel 2 320y.

The docketing user may expand all panels 320 through selection of the maximize all panels object 312. The result of selecting the maximize all panels object 312 includes all panels 320 being expanded as illustrated in FIG. 5B. As shown in FIG. 5B, not only is Panel 2 320y expanded, now Panel 1 320x and Panel 3 320z are also expanded as a result of the docketing user request to expand all panels 320. Within each of the Panel 1 320x and Panel 3 320z, Panel 1 and Panel 3 fields 322x and 322z are also displayed. Within Panel 1 320x, the Panel 1 fields 322x may include the Panel 1 metadata entry area 350x for Field 1-1. Within Panel 3 320z, the Panel 3 fields 322z may include the Panel 3 metadata entry area 350z for Field 3-1. Additionally, as described with reference to FIG. 3, each panel 320 may also include one or more subpanels 360. Accordingly, in FIG. 5B a SubPanel 1-1 360x is illustrated. Within the SubPanel 1-1 360x, SubPanel 1-1 fields 322xx include the SubPanel 1-1 metadata entry area 350xx for Field 1-1-1. Each expanded panel 320 and expanded subpanel 360 may also include the minimize panel UI object 330.

To minimize all panels 320 within the docketing interface 300, the docketing user selects the minimize all panels UI object 310 shown in FIGS. 5A and 5B. The result of selecting the minimize all panels UI object 310 may include all panels 320 being collapsed as illustrated in FIG. 6. Each collapsed panel 320 includes the maximize panel UI object 340, and now hides the fields 322 and/or the subpanel(s) 360. The docketing user may request that a current layout of the docketing interface 300 be saved and associated with the docketing user by selecting the save layout UI object 314. A saved layout may include a position for each panel 320, a state for each panel 320 that indicates whether the panel 320 is expanded or collapsed. Whenever the docketing user next opens the docketing interface 300, the panels 320 are displayed according to the saved layout.

As mentioned above with reference to FIG. 3, the docketing interface 300 may be displayed as a result of the IA search. If the docketing interface 300 is displayed as a result of the IA search then search result objects are included within the docketing interface 300. The search result objects may include the previous record object 302, the search result set UI object 304, and the next record object 306.

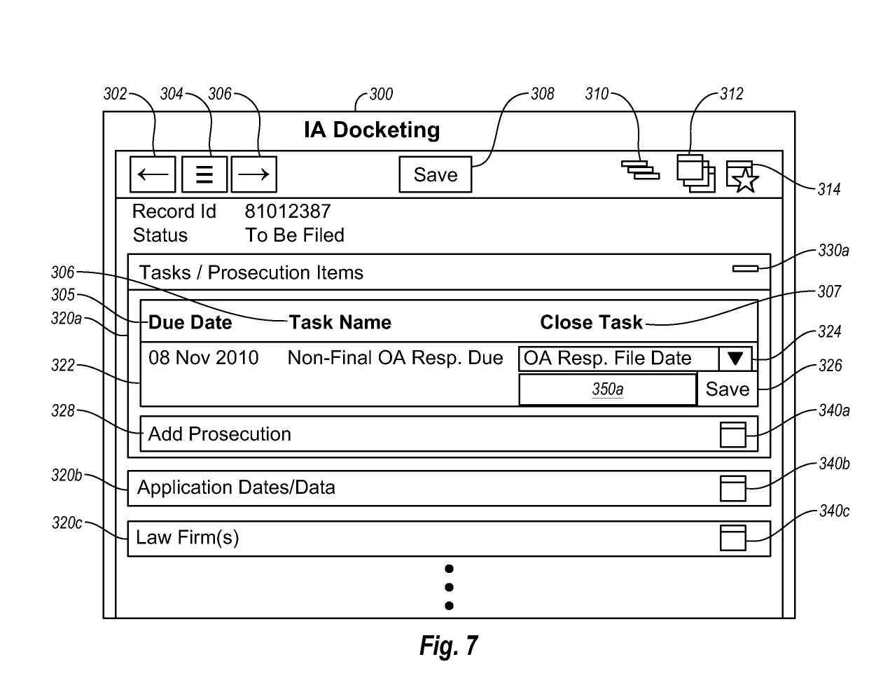

Referring now to FIG. 7, in response to the docketing user selection of the previous record UI object 302 or the next record object 306, the docketing interface 300 for a second IA record 200 is displayed. In some embodiments, positions and states of the panels 320 from the docketing interface 300 for the first IA record 200 may be maintained. Maintenance of positions and states of the panels 320 within the docketing interface 300 when transitioning between display of different IA records 200 allows the docketing user to quickly and easily transition between IA records 200 to view and/or modify the same metadata for each of the IA records 200.

For example, with combined reference to FIGS. 3 and 7, if the docketing user selects the previous record object 302 or the next record object 306 for the first IA record 200 (FIG. 3), the first IA record 200 with the record identifier 210 having a value of ‘81012345’ and the asset status 250 having a value of “To Be Filed”, the docketing interface 300 transitions to display metadata associated with the second IA record 200 (FIG. 7) with, for example, the same panels 320 expanded and collapsed. The second IA record 200 has the record identifier 210 set to a value of ‘81012387’ and the asset status 250 set to a value of “Filed”. Additionally, values for the due date field 305 and the task name field 306 in FIG. 3 are ‘29 Oct. 2009’ and ‘Application-Instruct OC’, respectively, while in FIG. 7 values for the due date field 305 and the task name field 306 are ‘8 Nov. 2010’ and Non-Final OA Resp. Due', respectively.

Thus, for the second IA record 200, the fields 322 indicate for the task 270 that a response to a non-final office action is due by Nov. 8, 2010. The docketing user may then transition between IA records 200 and view and/or close tasks within the first 320a, which is a tasks and prosecution items panel.

The docketing server 130 may derive the drop-down 324 and the metadata entry area 350 to display in the first panel 320a based on a preconfigured workflow and/or country rules for at least one of the asset type 220 and the open task 270. In the example illustrated in FIG. 7, the asset type 220 may be either a patent or a trademark. Because the open task 270 is Non-Final OA Resp. Due', one value for the drop-down 324 may be ‘OA Resp. Filed Date’, indicating that docketing user input into the date metadata entry area 350a will signify a date on which the non-final office action was responded to. An additional value for the drop-down 324 may be ‘Instructions Sent Date’ to signify that docketing user input into the date metadata entry area 350a will denote a date on which instructions were sent to counsel to respond to the non-final office action on behalf of the docketing user. While the above examples have been limited to date values, the drop-down 324 in the metadata entry area 350 may also be utilized with other types of data, such as numbers or text strings, for instance.

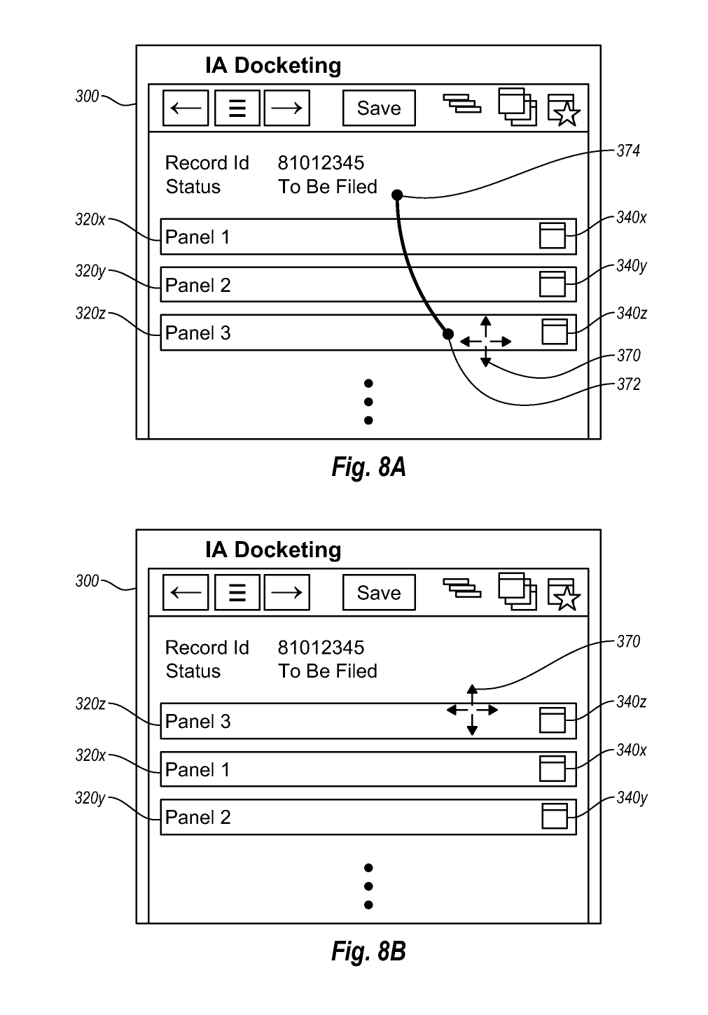

As illustrated in FIGS. 8A and 8B, each panel 320 can be relocated to another location within the docketing interface 300. The docketing user selects a panel 320, for example, Panel 3 320z. An optional panel movement object 370 may be displayed on the docketing interface 300 for panel selection and movement. The docketing user may move Panel 3 320z along a path from a first point 372 to a second point 374 as illustrated in FIG. 8A. Once the docketing user is satisfied with a new location of Panel 3 320z, the docketing user deselects Panel 3 320z. The Panel 3 320z is thereby relocated to the second point 374 above the Panel 1 320x and Panel 2 320y. Movement of the panels 320 allows the docketing user to relocate metadata that is of particular relevance to the docketing user towards the top of the docketing interface 300 for ease of access. FIGS. 8A and 8B illustrate collapsed panels, but the docketing user may also move expanded panels as described above.

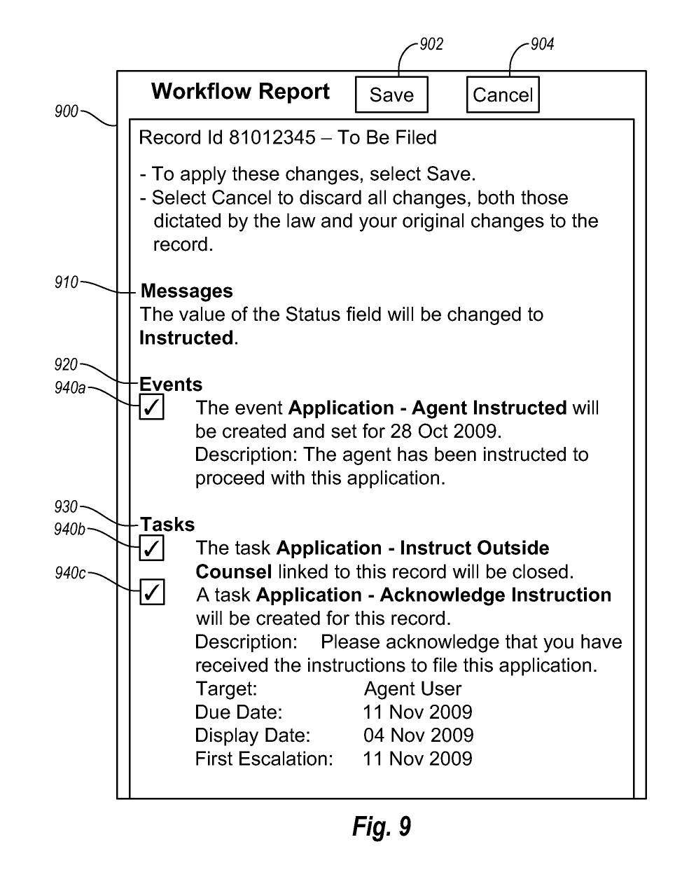

FIG. 9 illustrates a workflow report UI object 900. The workflow report UI object 900 provides some details on changes to be made to the IA record 200 as a result of user input into one field 322 within the docketing interface 300. For example, with reference to FIG. 3, user entry of a date into the date metadata entry area 350a and selection of the save metadata object 326a triggers analysis of the preconfigured workflow and the country rules to determine and display, within the workflow report UI object 900, a list of one or more actions to be triggered by the user input. The docketing user can confirm the listed actions by selecting a save actions object 902. Alternatively, the docketing user can prevent the listed actions from occurring by selecting a cancel actions object 904.

The listed actions within the workflow report UI object 900 detail changes to be made to the IA record 200 upon confirmation, wherein the confirmation includes selection of the save actions object 902. Some examples of the listed actions may include messages 910, events 920, tasks 930, or some combination thereof. The messages 910 include informative details on various modifications to be made to the IA record 200, such as field value changes. The events 920 include a list of events 280 to be recorded in the IA record 200. The tasks 930 include a list of tasks 270 to be closed or created for the IA record 200.

Additionally, the workflow report UI object 900 may include an action checkbox 940 for each event 920 and each task 930. In some embodiments, by default the action checkbox 940 is checked, which may indicate that the corresponding action should occur upon confirmation of the workflow report UI object 900. In these and other embodiments, by unchecking the action checkbox 940, the docketing user may indicate that the corresponding action should not occur upon confirmation of the workflow report 900. For example, if the docketing user unchecks the action checkbox 940a, the corresponding action, in this case an indication that an agent has been instructed to proceed with the application, would not be recorded within the IA record 200. If, however, the docketing user leaves the action checkbox 940b checked, then the corresponding action, the task 270 to instruct outside counsel to file an application, would be closed upon confirmation of the list of actions within the workflow report 900.

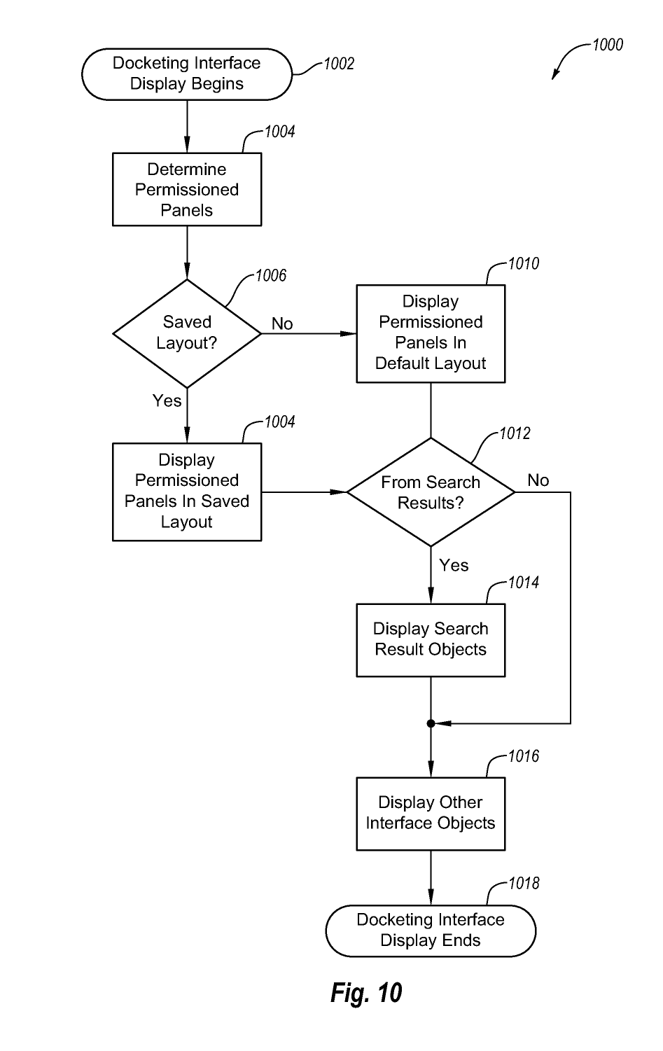

FIG. 10 is a flow diagram depicting an example method 1000 for display of the docketing interface 300. The method 1000 may be performed by an electronic device, such as the docketing server 130 of FIG. 2A. Specifically, in some embodiments, the docketing interface 300 may be displayed on the user device 110. However, in these and other embodiments, the docketing server 130 may define the interface 300 and interaction with the docketing user. That is, the docketing server 130 may send client-side scripts to the user device 110 so the user device 110 can respond to docketing user requests and input. Thus, some steps of the method 1000 may be performed at the user device 110, but may be performed according to a predetermined manner by the docketing server 130.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

At 1002, the method 1000 begins. At step 1004, the controller 132 determines permissioned panels 320. The permissioned panels 320 may be a subset of the all-available panels 320 for the docketing interface 300. For each docketing user there is a defined permission for each panel 320.

At step 1006, the controller 132 determines whether there is a saved layout. If, at step 1006, there exists the saved layout for the current docketing user, then the controller 132 displays permissioned panels 320 according to the saved layout at 1008. If instead at step 1006 the saved layout does not exist for the current docketing user, then the controller 132 displays permissioned panels according to a default layout at step 1010.

At step 1012, the controller 132 determines whether the docketing interface 300 is a result of an IA search. If at step 1012 the controller 132 determines that the docketing interface 300 is displayed from a set of IA record search results, then the controller 132 at 1014 displays the search result objects such as the previous record object 302, the search result set UI object 304, and the next record object 306 of FIG. 3. If instead, at step 1012, the controller 132 determines the docketing interface 300 is not the result of an IA search, the method 1000 proceeds to 1016. At step 1016, other interface objects are displayed within the docketing interface 300. For example, the minimize all panels object 310, the maximize all panels object 312, the save layout UI object 314, the plurality of related fields 322, and the like. The method 1000 ends at 1018.

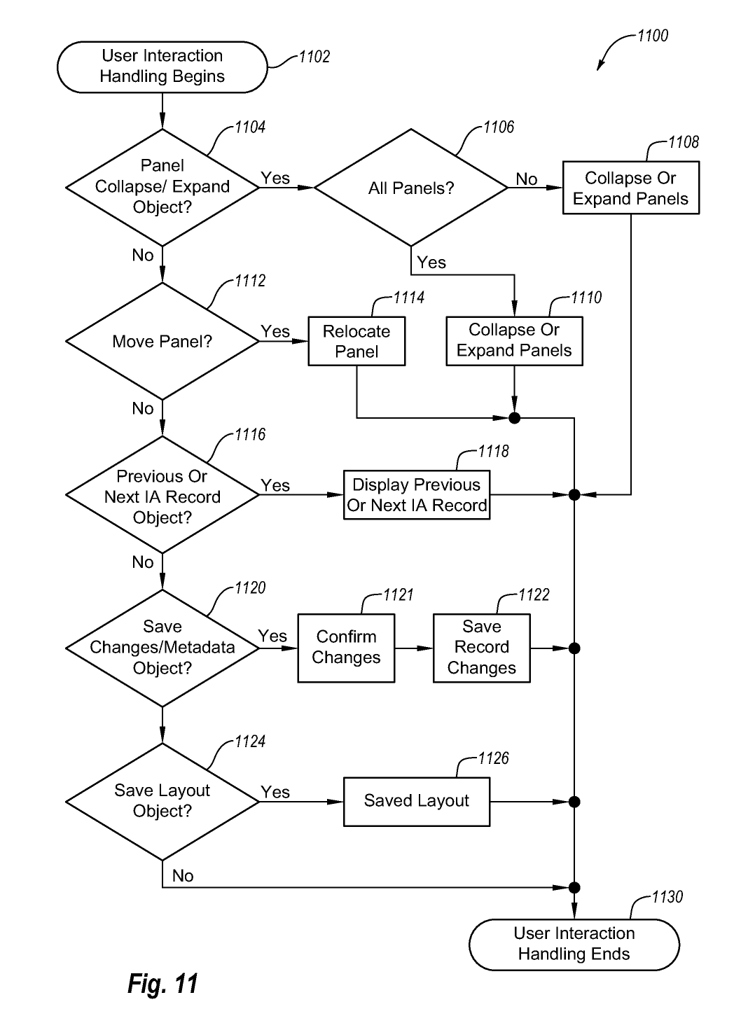

FIG. 11 is a flow diagram depicting an example method 1100 for handling user interaction with the docketing interface 300. The method 1100 may be performed by an electronic device, such as the docketing server 130 of FIG. 2A. Specifically, in some embodiments, the docketing interface 300 may be displayed on the user device 110. However, in these and other embodiments, the docketing server 130 may define the interface 300 and interaction with the docketing user. That is, the docketing server 130 may send client-side scripts to the user device 110 so the user device 110 can respond to docketing user requests and input. Thus, some steps of the method 1000 may be performed at the user device 110, but may be performed according to a predetermined manner by the docketing server 130. If, for example, the docketing system 100 is web-based, then the docketing server 130 may send JavaScript details to the user device 110 that the user device 110 may utilize to provide some of the functionality described as follows.

At 1102, the method 1100 begins. At 1104, the controller 132 determines whether the docketing user has selected to collapse or expand one or more panels 320. If the controller determines the docketing user has selected to collapse or expand one or more panels 320 the method 1100 continues to 1106. If instead the controller 132 determines the docketing user has not selected to collapse or expand one or more panels 320, the method 1100 continues to 1112.

At 1106, the controller 132 determines whether the docketing user has selected to collapse or expand all the panels 320. If at 1106 the controller 132 determines that the docketing user selects the minimize panel UI object 330, the controller 132 collapses the corresponding panel 320 at step 1108. Additionally, if the controller 132 determines that the docketing user selects the maximize panel object 340, the controller 132 expands the corresponding panel 320 at step 1108. If at 1106 the controller 132 determines that the docketing user selects the minimize all panels object 310, the controller 132 collapses all panels 320 at step 1110. Additionally, if the controller 132 determines that the docketing user selects the maximize all panels object 312, the controller 132 expands all panels 320 at step 1110.

At 1112, the controller 132 determines whether the docketing user requests to move a selected panel 320. If at 1112 the docketing user requests to move the selected panel, the controller 132 relocates the selected panel within the docketing interface 300 according to the user request at step 1114. If the docketing user does not request to move the selected panel, the method 1100 continues to 1116.

At 1116, the controller 132 determines whether the docketing user selects the previous or the next record object. If the docketing user selects the previous record object 302 at 1116, the controller 132 displays the previous IA record 200 at step 1118. If at step 1116 the docketing user selects the next record object 306, then the control 132 displays the next IA record 200 at step 1118. If the controller 132 determines the docketing user does not select the previous of the next record object, the method 1100 continues to 1120.

At 1120, the controller 132 determines whether the docketing user selects to save changes or metadata. If the controller 132 determines the docketing user selects the save changes object 308 or the save metadata object 328, method 1100 continues to 1121. If the controller 132 determines the docketing user does not select to save changes or metadata, the method 1100 continues to 1124.

At 1121, the controller 132 prompts the docketing user for user confirmation of a list of actions that will cause changes to the IA record 200 as shown in the work flow report object such as the work flow report object 900 in FIG. 9. When the docketing user confirms the listed changes, the controller 132 saves changes that the user made and saves any additional changes made as a result of the predefined workflow in step 1122.

At 1124, the controller 132 determines whether the docketing user selects to save a current layout for the docketing interface 300. The docketing user can save the current layout of the docketing interface 300 by selecting the saved layout object 314 at step 1124. If at 1124, the controller 132 determines the docketing user selects to save a current layout, the method 1100 continues to 1126. If the controller 132 determines the docketing user does not select save a current layout, the method 1100 continues to 1130. At 1126, the controller 132 saves the current layout of the docketing interface 300 for the current docketing user. The method 1100 ends at 1130.

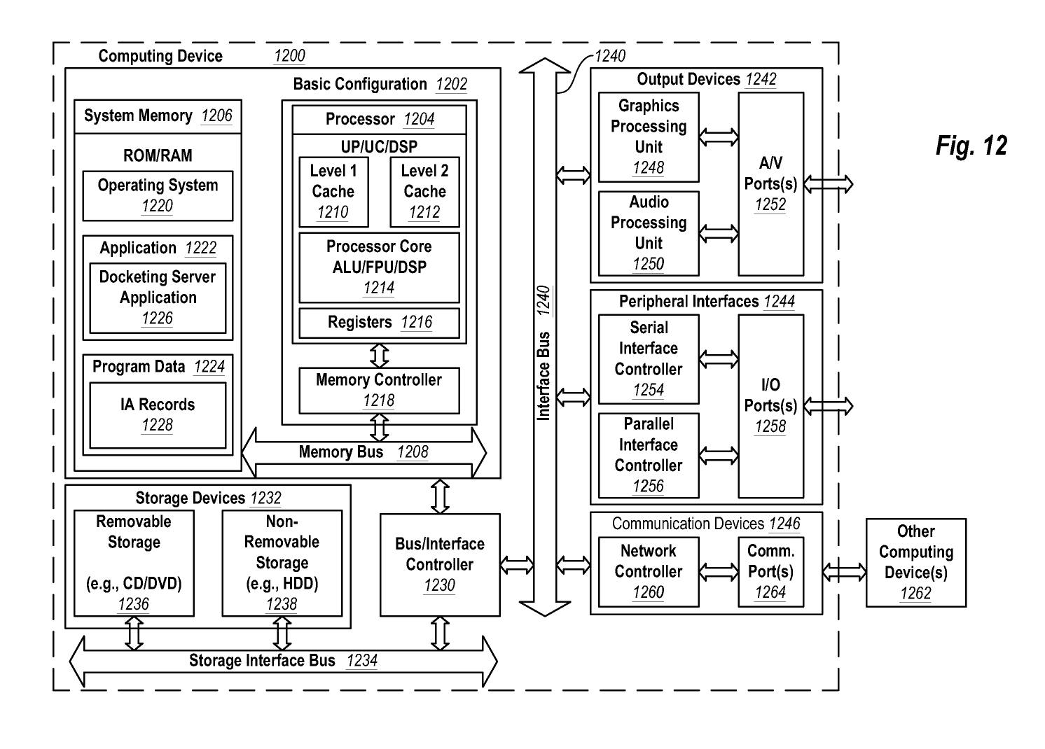

FIG. 12 is a block diagram illustrating an example computing device 1200 that is arranged for handling user interaction with the docketing interface 300 and/or displaying the docketing interface 300 in accordance with the present disclosure. In a basic configuration 1202, computing device 1200 typically includes one or more processors 1204 and a system memory 1206. A memory bus 1208 may be used for communicating between processor 1204 and system memory 1206.

Depending on the desired configuration, processor 1204 may be of any type including but not limited to a microprocessor (μP), a microcontroller (μC), a digital signal processor (DSP), or any combination thereof. Processor 1204 may include one more levels of caching, such as a level one cache 1210 and a level two cache 1212, a processor core 1214, and registers 1216. An example processor core 1214 may include an arithmetic logic unit (ALU), a floating point unit (FPU), a digital signal processing core (DSP Core), or any combination thereof. An example memory controller 1218 may also be used with processor 1204, or in some implementations memory controller 1218 may be an internal part of processor 1204.

Depending on the desired configuration, system memory 1206 may be of any type including but not limited to volatile memory (such as RAM), non-volatile memory (such as ROM, flash memory, etc.) or any combination thereof. System memory 1206 may include an operating system 1220, one or more applications 1222, and program data 1224. Application 1222 may include a docketing server application 1226 that is arranged to provide a docketing interface 300 for the management of IA records 200. Program data 1224 may include IA records 1228 and/or metadata related to the IA records 200 that may be useful for managing IA records 200 through a docketing interface 300 as is described herein. In some embodiments, application 1222 may be arranged to operate with program data 1224 on operating system 1220 such that handling user interaction with the docketing interface 300 and/or displaying the docketing interface 300 may be performed on the computing device 1200. This described basic configuration 1202 is illustrated in FIG. 12 by those components within the inner dashed line.

Computing device 1200 may have additional features or functionality, and additional interfaces to facilitate communications between basic configuration 1202 and any required devices and interfaces. For example, a bus/interface controller 1230 may be used to facilitate communications between basic configuration 1202 and one or more data storage devices 1232 via a storage interface bus 1234. Data storage devices 1232 may be removable storage devices 1236, non-removable storage devices 1238, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1206, removable storage devices 1236, and non-removable storage devices 1238 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1200. Any such computer storage media may be part of computing device 1200.

Computing device 1200 may also include an interface bus 1240 for facilitating communication from various interface devices (e.g., output devices 1242, peripheral interfaces 1244, and communication devices 1246) to basic configuration 1202 via bus/interface controller 1230. Example output devices 1242 include a graphics processing unit 1248 and an audio processing unit 1250, which may be configured to communicate to various external devices such as a display or speakers via one or more A/V ports 1252. Example peripheral interfaces 1244 include a serial interface controller 1254 or a parallel interface controller 1256, which may be configured to communicate with external devices such as input devices (e.g., keyboard, mouse, pen, voice input device, touch input device, etc.) or other peripheral devices (e.g., printer, scanner, etc.) via one or more I/O ports 1258. An example communication device 1246 includes a network controller 1260, which may be arranged to facilitate communications with one or more other computing devices 1262 over a network communication link via one or more communication ports 1264.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1200 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1200 may also be implemented as a personal computer including both laptop computer and non-laptop computer configurations.

The previously described versions of the present invention have many advantages, including providing a customizable docketing interface which each docketing user can personalize to suit his or her metadata access needs. Additionally, the docketing server advantageously derives drop-down and metadata entry area to display in a panel based on preconfigured workflow, providing quick access to open task management. Movement of panels advantageously allows a docketing user to relocate metadata that is of particular relevance to the docketing user towards the top of the docketing interface object for ease of access. Related fields that are not of interest to the docketing user can be hidden by collapsing panels that contain those uninteresting fields. This frees the docketing interface from unnecessary clutter, and allows the docketing user to more quickly review and access specific metadata of interest. The present invention does not require that all the advantageous features and all the advantages need to be incorporated into every embodiment of the invention.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of intellectual asset docketing comprising:
displaying a customizable docketing interface for a first intellectual asset record, the docketing interface including a plurality of panels, wherein each panel of the plurality of panels includes a plurality of related fields;
detecting user input into a first field of the docketing interface; and
closing at least one task for the first intellectual asset record based at least in part on the user input.

2. The method of claim 1 wherein the user input comprises at least one of a date and a reference identifier.

3. The method of claim 2 further comprising storing the user input for the first field in the intellectual asset record.

4. The method of claim 1 further comprising displaying, for the first field, an indication of the at least one task to be closed in response to the user input into the first field.

5. The method of claim 1 further comprising deriving the first field to display based on a preconfigured workflow for at least one of an intellectual asset type and the at least one task.

6. The method of claim 1 wherein at least one panel of the plurality of panels further comprises at least one subpanel.

7. The method of claim 1 further comprising displaying at least one field of the plurality of fields within a panel of the plurality of panels in response to a user request to expand the panel.

8. The method of claim 7 further comprising hiding the plurality of fields within the panel in response to a user request to collapse the panel.

9. The method of claim 1 further comprising hiding the plurality of fields within the plurality of panels in response to a user request to collapse all panels of the plurality of panels.

10. The method of claim 1 further comprising displaying the plurality of fields within the plurality of panels in response to a user request to expand all panels of the plurality of panels.

11. The method of claim 1 further comprising relocating a panel of the plurality of panels in response to a user request to move the panel to a new location within the docketing interface.

12. The method of claim 1 further comprising:
saving a current layout of the docketing interface; and
associating the layout with a docketing user.

13. The method of claim 12, wherein the layout comprises a position for each panel of the plurality of panels.

14. The method of claim 13, wherein the layout further comprises a state for each panel of the plurality of panels, the state indicating whether the panel is expanded or collapsed.

15. The method of claim 1 further comprising hiding one or more panels of the plurality of panels based on panel permissions for a docketing user.

16. The method of claim 1 further comprising:
displaying a list of one or more actions to be triggered by the user input; and
prompting a docketing user to confirm the list prior to the closure of the at least one task.

17. The method of claim 1, wherein the docketing interface further comprises at least one of a previous record object and a next record object.

18. The method of claim 17 further comprising displaying the docketing interface for a second intellectual asset record in response to user selection of one of the previous record object and the next record object, wherein displaying the docketing interface for the second intellectual asset record comprises maintaining positions and states of the plurality of panels from the docketing interface for the first intellectual asset record.

19. The method of claim 1 further comprising creating at least one new task for the first intellectual asset record based at least in part on the user input.

20. The method of claim 1 wherein the docketing interface is a subcomponent of a parent interface.

21. A computer storage medium having computer executable instructions stored thereon for performing the method of claim 1.

22. A docketing server comprising:
at least one memory device for storing one or more intellectual asset records; and
a controller operatively connected to the at least one memory device, wherein the controller is configured to:
display a customizable docketing interface for a first intellectual asset record, the docketing interface including a plurality of panels, wherein each panel of the plurality of panels includes a plurality of related fields,
detect user input into a first field of the docketing interface, and
close at least one task for the first intellectual asset record based at least in part on the user input.

23. The docketing server of claim 22 wherein the user input comprises at least one of a date and a reference identifier.

24. The docketing server of claim 23 wherein the controller further stores the user input for the first field in the intellectual asset record.

25. The docketing server of claim 22 wherein the controller further displays, for the first field, an indication of the at least one task to be closed in response to the user input into the first field.

26. The docketing server of claim 22 wherein the controller further derives the first field to display based on preconfigured workflow for at least one of an intellectual asset type and the at least one task.

27. The docketing server of claim 22 wherein at least one panel of the plurality of panels further comprises at least one subpanel.

28. The docketing server of claim 22 wherein the controller further displays at least one field of the plurality of fields within a panel of the plurality of panels in response to a user request to expand the panel.

29. The docketing server of claim 28 wherein the controller further hides the plurality of fields within the panel in response to a user request to collapse the panel.

30. The docketing server of claim 22 wherein the controller further hides the plurality of fields within the plurality of panels in response to a user request to collapse all panels of the plurality of panels.

31. The docketing server of claim 22 wherein the controller further displays the plurality of fields within the plurality of panels in response to a user request to expand all panels of the plurality of panels.

32. The docketing server of claim 22 wherein the controller further relocates a panel of the plurality of panels in response to a user request to move the panel to a new location within the docketing interface.

33. The docketing server of claim 22 wherein the controller further:
saves a current layout of the docketing interface; and
associates the layout with a docketing user.

34. The docketing server of claim 33, wherein the layout comprises a position for each panel of the plurality of panels.

35. The docketing server of claim 34, wherein the layout further comprises a state for each panel of the plurality of panels, the state indicating whether the panel is expanded or collapsed.

36. The docketing server of claim 33, wherein the docketing interface further comprises at least one of a previous record object and a next record object.

37. The docketing server of claim 36 wherein the controller further displays the docketing interface for a second intellectual asset record in response to user selection of one of the previous record object and the next record object, wherein displaying the docketing interface for the second intellectual asset record comprises maintaining positions and states of the plurality of panels from the docketing interface for the first intellectual asset record.

38. The docketing server of claim 22 wherein the controller further hides one or more panels of the plurality of panels based on panel permissions for a docketing user.

39. The docketing server of claim 22 wherein the controller further:
displays a list of one or more actions to be triggered by the user input; and
prompts a docketing user to confirm the list prior to the closure of the at least one task.

40. The docketing server of claim 22 wherein the controller further creates at least one new task for the first intellectual asset record based at least in part on the user input.

41. The docketing server of claim 22 wherein the docketing interface is a subcomponent of a parent interface.
